(19) United States
(12) Patent Application Publication
(10) Pub. No.: US 2024/0180149 A1
(43) Pub. Date: Jun. 6, 2024

(54) FIRE ANT BAITS WITH ENHANCED SELECTIVITY

(71) Applicant: The United States of America, as represented by the Secretary of Agriculture, Washington, DC (US)

(72) Inventor: JIAN CHEN, GREENVILLE, MS (US)

(21) Appl. No.: 18/504,308

(22) Filed: Nov. 8, 2023

Related U.S. Application Data
(60) Provisional application No. 63/386,088, filed on Dec. 5, 2022.

(51) Int. Cl. A01N 25/00; A01N 43/40

(52) U.S. Cl. CPC A01N 25/006; A01N 43/40

(57) ABSTRACT

The present disclosure relates to compositions with enhanced selectivity for fire ants over non-target organisms. The compositions comprise at least one fire ant food source and at least one fire ant venom alkaloid. The compositions optionally comprise a carrier and/or an insecticide. The compositions are useful for inhibiting feeding by non-target organisms on a bait comprising the composition.

### REFERENCE TO RELATED APPLICATION

This application claims the benefit of U.S. Provisional Application No. 63/386,088, filed 5 Dec. 2022, which is incorporated herein by reference in its entirety.

### FIELD OF THE INVENTION

The disclosure relates to baits with enhanced selectivity for fire ants over non-target organisms, such baits comprising at least one fire ant food source, at least one fire ant venom alkaloid, optionally a carrier, and optionally an insecticide.

### BACKGROUND OF THE INVENTION

Red imported fire ants, Solenopsis invicta (Buren), are an important invasive pest with well documented negative impact on the public health, agricultural productivity, and biodiversity. They cause over US$6.7 billion in annual loss in the United States alone. Bait has been a major tool used in controlling fire ants after a mirex-based bait was developed in 1960s. After the U.S. Environmental Protection Agency (EPA) discontinued all the mirex registrations, several new active ingredients were registered by EPA. However, the basic formulation of fire ant bait has never been changed. All current fire ant baits in the market still use soybean oil as a food source and pregel defatted corn grit as a carrier. Any organism feeding on vegetable oil can potentially be a non-target organisms of fire ant baits. Since soybean oil is a preferred food source for many ant species, fire ant baits are attractive to a wide range of native ants. The non-target effect of fire ant bait on native ants has been well studied.

For controlling any pest ants, the ideal outcome is to preserve native ant species following the removal of the target ants. Ants are an important component of the soil communities, mediating various ecosystem services. They are important predators and preys of other predators, such as spiders. Ants also engage in symbiosis with various organisms. They are useful ecological indicators. Given the ecological importance of ants, effective conservation of ants is critically important. Particular efforts are needed to protect ants that are endemic and threatened. Introduction of red imported fire ants is a great threat to biodiversity; however, fire ant control practices using non-selective chemicals, such as bait, may worsen the situation by impacting the native ant populations.

Low selectivity of ant bait has been a significant and long-standing problem, particularly in areawide eradication programs. Fire ant bait products are no exception. Fire ant bait selectivity may be improved by using pheromone attractants, phagostimulants, and biological control agents. Great effort has been made in bait development using fire ant pheromone attractants.

Another approach to improve ant bait selectivity is to use different food sources, even the prey of the target ants. For example, Asian needle ants, Brachyponera chinensis, predate on termites and they are a termite specialist. Fipronil-treated termites were found to be highly effective against Asian needle ants, but with negligible effects on native ants. A similar approach has been tried for fire ant baits. For example, fly pupae was studied as a food source and carrier of fire ant baits. The result showed a significant improvement in the bait selectivity. Unfortunately, none of these approaches have been successfully applied in the current fire ant bait products in the market.

Venom is used by fire ants in both offense and defense. The venomous stings are effective for attacking intruders, such as humans and other animals, and for immobilizing prey. Due to the significance of fire ants to public health, the venom chemistry has been extensively studied. The major components of fire ant venom are 2-methyl-6-alkyl (or alkenyl) piperidines (solenopsins), with minor compounds including a series of piperideine and pyridine alkaloids and proteins. Venom secretion is widely used by ants for disease control and more generally as an external surface disinfectant. Fire ants feed their nestmates with their own venom. Piperidine alkaloids were found in crops and midguts of ants at concentration levels that have previously been reported as effective against various pathogens. These venom alkaloids were also found in midguts of the larvae, indicating that trophallaxis must be involved in the transfer of venom, since larvae do not produce alkaloids and they depend on workers to be fed. After the mating flight, the female alates shed their wings, burrow into the soil, and start new colonies. The new queen provided alkaloids to her first batch of larvae in the new colony. Since the crops of female alates contain venom alkaloids donated from their nestmate workers, the transfer of worker alkaloids to new generation occurred. After minim adult workers emerged, they took the role in providing venom to the larvae in the colony. Minim adult workers eventually died out and the normal workers became the venom donors in the colony. Although other functions may be possible, considering the well-known antimicrobial property of venom alkaloids and their detected concentration levels, venom in the digestive system is most likely used as an internal antibiotic by fire ants.

Thus, there is currently a need for baits with enhanced selectivity for fire ants over non-target organisms.

### SUMMARY OF THE INVENTION

Provided herein are compositions comprising at least one fire ant food source, at least one fire ant venom alkaloid, optionally a carrier, and optionally an insecticide. The compositions are useful as baits with enhanced selectivity for fire ants over non-target organisms.

In an embodiment, the invention relates to a composition comprising at least one fire ant food source, at least one fire ant alkaloid, optionally a carrier, and optionally an insecticide. In some embodiments of the invention, the fire ant food source in the composition is a vegetable oil. In some embodiments of the invention, the vegetable oil is canola oil, cottonseed oil, grapeseed oil, rapeseed oil, soybean oil, safflower oil, peanut oil, corn oil, olive oil, palm oil, or sunflower oil. In some embodiments of the invention, the at least one fire ant venom alkaloid in the composition of the invention is a 2,6-dialkyl(or alkenyl)piperidine, a 2-methyl-6-alkyl (or alkenyl)pyridine, a 2-methyl-6-alkyl (or alkenyl)piperideine, or a mixture thereof. In some embodiments of the invention, the at least one solenopsin in the composition of the invention is trans-solenopsin A, cis-isosolenopsin A, trans-solenopsin B, cis-isosolenopsin B, trans-solenopsin C, cis-isosolenopsin C, trans-solenopsin D, cis-isosolenopsin D, trans-dehydrosonenopsin A, cis-dehydroisosolenopsin A, trans-dehydrosonenopsin B, cis-dehydroisosolenopsin B, trans-dehydrosonenopsin C, cis-dehydroisosolenopsin C, trans-dehydrosonenopsin D, cis-dehydroisosolenopsin D, or a mixture thereof.

In an embodiment, the invention relates to a method for selectively attracting fire ants over non-target organisms, said method comprising treating an object or area with an effective amount of a composition comprising at least one fire ant food source, at least one fire ant venom alkaloid, optionally a carrier, and optionally an insecticide, wherein the composition presents with enhanced selectively for fire ants over non-target organisms.

In an embodiment, the invention relates to a kit comprising at least one fire ant food source, at least one fire ant venom alkaloid, optionally a carrier, and optionally an insecticide to be used as a bait with enhanced selectivity for fire ants over non-target organisms.

### BRIEF DESCRIPTION OF THE DRAWINGS

FIG. 1A and FIG. 1B depict exemplary schematics of the field feeding setups useful in the ant-feeding assays. FIG. 1A shows an exemplary schematic setup for a multichoice bioassay. FIG. 1B shows an exemplary schematic setup for a two-choice bioassay.

FIG. 2A and FIG. 2B depict graphs of the percentage oil consumption of fire ants in multi-choice bioassays. FIG. 2A shows the percentage oil consumption when trans-solenopsin A was present at 0, 6.6, 3.3, 1.7, 0.8, and 04 mg/g. FIG. 2B shows the percentage oil consumption when trans-solenopsin A was present at 0, 0.2, 0.1, 0.05, 0.03, and 0.015 mg/g. The Y axis shows the percentage (%) oil consumption. The X axis shows the trans-solenopsin A concentration in mg/g.

FIG. 3A to FIG. 3F depict graphs of the percentage oil consumption of fire ants in two choice bioassays. FIG. 3A shows data for trans-solenopsin A at 6.6 mg/g. FIG. 3B shows data for trans-solenopsin A at 3.3 mg/g. FIG. 3C shows data for trans-solenopsin A at 1.66 mg/g. FIG. 3D shows data for trans-solenopsin A at 0.83 mg/g. FIG. 3E shows data for trans-solenopsin A at 0.42 mg/g. FIG. 3F shows data for trans-solenopsin A at 0.27 mg/g. The Y axis shows the percentage (%) oil consumption. The X axis shows the treatments.

FIG. 4A to FIG. 4F depict graphs of the percentage oil consumption of little black ants in two choice bioassays. FIG. 4A shows data for trans-solenopsin A at 6.6 mg/g. FIG. 4B shows data for trans-solenopsin A at 3.3 mg/g. FIG. 4C shows data for trans-solenopsin A at 1.66 mg/g. FIG. 4D shows data for trans-solenopsin A at 0.83 mg/g. FIG. 4E shows data for trans-solenopsin A at 0.42 mg/g. FIG. 4F shows data for trans-solenopsin A at 0.27 mg/g. The Y axis shows the percentage (%) oil consumption. The X axis shows the treatments.

FIG. 5A to FIG. 5D depict graphs of the percentage oil consumption of thief ants in two choice bioassays. FIG. 5A shows data for trans-solenopsin A at 6.6 mg/g. FIG. 5B shows data for trans-solenopsin A at 3.3 mg/g. FIG. 5C shows data for trans-solenopsin A at 1.66 mg/g. FIG. 5D shows data for trans-solenopsin A at 0.83 mg/g. The Y axis shows the percentage (%) oil consumption. The X axis shows the treatments.

### DETAILED DESCRIPTION

The present disclosure relates to compositions with enhanced selectivity for fire ants over non-target organisms. The compositions comprise at least one fire ant food source, at least one fire ant venom alkaloid, optionally a carrier, and optionally an insecticide. Also disclosed are methods for attracting fire ants with enhanced selectivity over non-target organisms, said method involving treating an object or area with an effective amount of a composition of the invention.

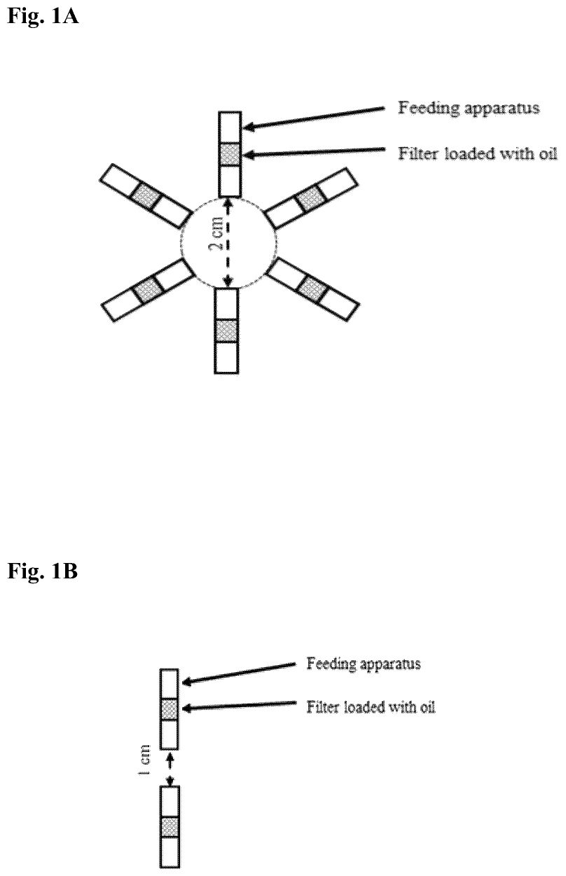

Low bait selectivity has been a significant and long-standing problem in fire ant management. In the instant disclosure multiple-choice and paired two-choice bioassays were used. An exemplary schematic of the multichoice bioassay field feeding setup is shown in FIG. 1A, and an exemplary schematic of the two-choice bioassay field feeding setup is shown in FIG. 1B.

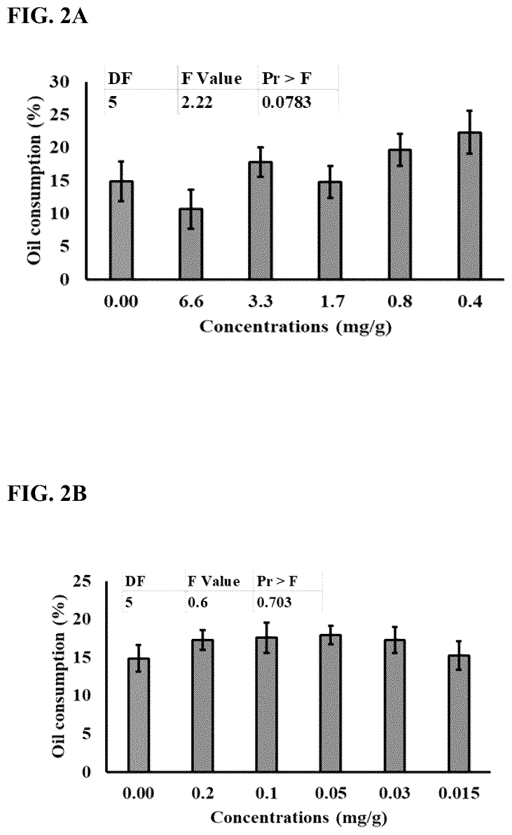

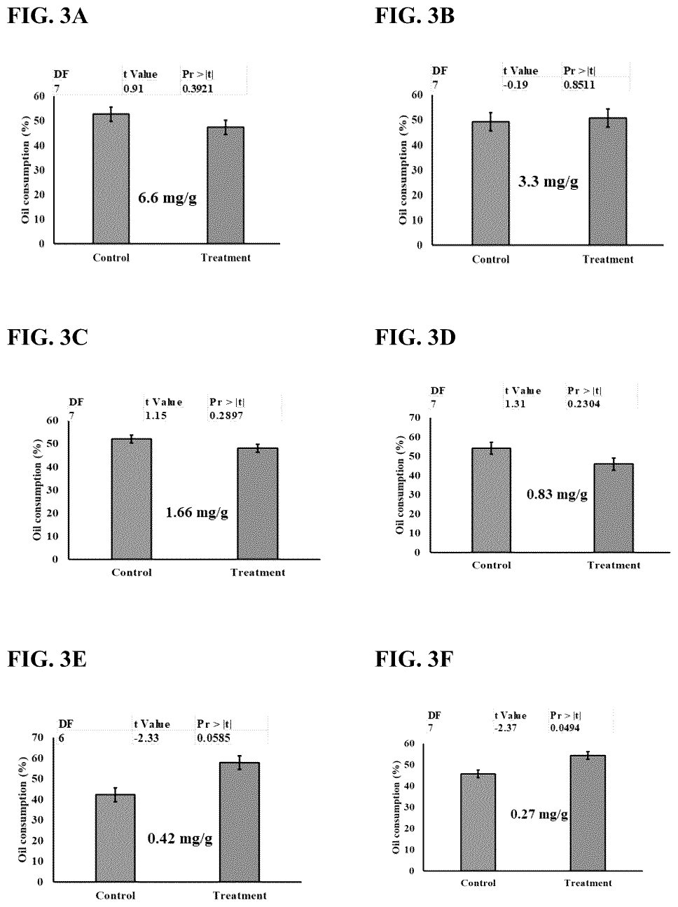

It was surprisingly found that trans-solenopsin A at concentrations up to 6600 ppm (6.6 mg/g) did not significantly affect the feeding preference of fire ants for soybean oil. In fact, at trans-solenopsin A concentrations of 420 and 270 ppm (0.42 and 0.27 mg/g), fire ants fed preferentially on oil treated with trans-solenopsin A over the control oil (soybean oil alone) when control oil was present. Ten concentrations of trans-solenopsis A in soybean oil were tested in two separate multiple-choice bioassays on fire ants. The results are shown in FIG. 2A and FIG. 2B. In both sets of multiple-choice bioassays different concentrations of trans-solenopsis A had no significant effect on oil consumption by fire ants. As seen in FIG. 2A, for the first set of concentrations. df=5, F=2.2, P=0.076, and as seen in FIG. 2B for the second set of concentrations df=5, F=0.6, P=0.703. Mean oil consumption percentage (%) of each choice over the total oil consumption were used in one-way ANOVA analysis. There was no significant difference in oil consumption among different concentrations for both sets of multiple-choice bioassays. Two-choice bioassays on fire ants were conducted at each of six concentrations of trans-solenopsis A in soybean oil, including 6.6, 3.3, 1.7, 0.8, 0.4, and 0.2 mg/g. The results are shown in FIG. 3A to FIG. 3F. Adding synthetic trans-solenopsin A into the soybean oil did not affect the feeding preference of fire ants to the soybean oil, even at very high concentration, such as 6.6 mg/g (6600 ppm) (df=7, t=0.91, P=0.39). In fact, at certain concentrations, such as 0.42 and 0.27 mg/g (420, 270 ppm), fire ants even feed preferentially on soybean oil containing trans-solenopsin A (at 0.42 mg/g, df=6, t=−2.33, P=0.0585; at 0.42 mg/g, df=7, t=−2.37, P=0.049).

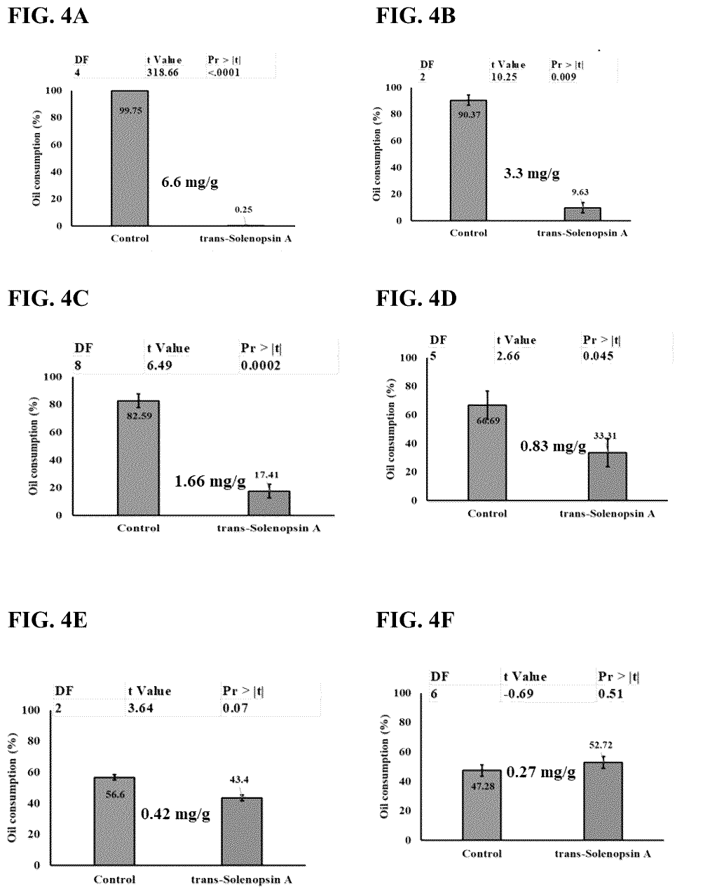

At 6.6 mg/g, trans-solenopsin A almost completely stopped little black ants, Monomorium minimum, and thief ants, Solenopsis molesta, from foraging on soybean oil. Two-choice bioassays on little black ants were conducted at each of six concentrations of trans-solenopsis A in soybean oil. As shown in FIG. 4A to FIG. 4F, trans-solenopsin A at concentrations of 6.6, 3.3, 1.66, and 0.83 significantly inhibited feeding by little black ants. At 6.6 mg/g, the feeding by little black ants was almost completely shut down. At 0.42 mg/g, the inhibition was very close to be statistically significant (P=0.07), and at concentrations >0.42 mg/g, trans-solenopsin A significantly inhibited the feeding by little black ants on soybean oil (P <=0.045).

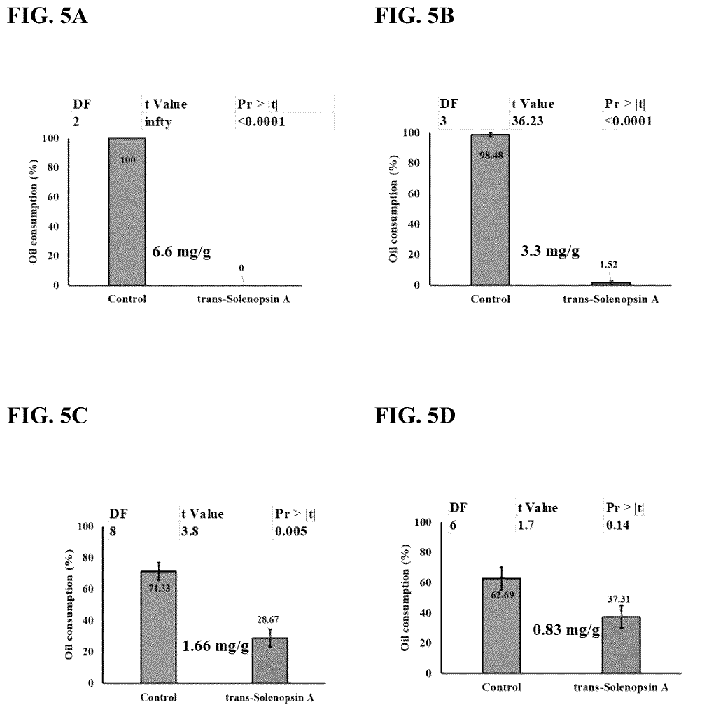

Two-choice bioassays on thief ants were conducted at each of four concentrations of trans-solenopsis A in soybean oil. As seen in FIG. 5A to FIG. 5D trans-solenopsin A at concentrations of 6.6, 3.3, and 1.66 significantly inhibited feeding by thief ants. At 6.6 mg/g, feeding by thief ants was completely shut down. At 0.80 mg/g, the inhibition was not statistically significant (P=0.14). At concentrations >=1.66 mg/g, trans-solenopsin A significantly inhibited feeding by thief ants on soybean oil (P<=0.005).

At concentrations of 6.6, 3.3, 1.66, and 0.83 mg/g Trans-solenopsisn A significantly inhibited feeding by little black ants. At 6.6, 3.3, and 1.66 mg/g Trans-solenopsisn A the feeding inhibition was significant for thief ants. Feeding by little black ants and by thief ants was almost completely inhibited at 6.6 mg/g Trans-solenopsisn A. Only 9.63% of oil consumed by little black ants was trans-solenopsin A treated 3.3 mg/g Trans-solenopsisn A. For thief ants, only 1.52% consumed oil was trans-solenopsin A-treated. Due to this dramatic difference in the response to trans-solenopsin A between fire ants and other two native ants, adding trans-solenopsin A into the soybean oil may be an easy and effective method to enhance the selectivity of fire ant bait products.

The fire ant food source in a composition with enhanced selectivity for fire ants can be any food source which will be consumed by fire ants. For example, the food source may be a vegetable oil such as canola oil, cottonseed oil, grapeseed oil, rapeseed oil, soybean oil, safflower oil, peanut oil, corn oil, olive oil, palm oil, or sunflower oil.

In an embodiment, the invention relates to a composition comprising at least one fire ant food source, at least one fire ant venom alkaloid, optionally a carrier, and optionally an insecticide. In some embodiments of the invention, the fire ant food source in the composition is a vegetable oil. In some embodiments of the invention, the vegetable oil is canola oil, cottonseed oil, grapeseed oil, rapeseed oil, soybean oil, safflower oil, peanut oil, corn oil, olive oil, palm oil, or sunflower oil. In some embodiments of the invention, the at least one fire ant venom alkaloid in the composition of the invention is a 2,6-dialkyl(or alkenyl)piperidine, a 2-methyl-6-alkyl (or alkenyl)pyridine, a 2-methyl-6-alkyl (or alkenyl)piperideine, or a mixture thereof. In some embodiments of the invention, the at least one 2,6-dialkyl(or alkenyl)piperidine in the composition of the invention is trans-solenopsin A, cis-isosolenopsin A, trans-solenopsin B, cis-isosolenopsin B, trans-solenopsin C, cis-isosolenopsin C, trans-solenopsin D, cis-isosolenopsin D, trans-dehydrosonenopsin A, cis-dehydroisosolenopsin A, trans-dehydrosonenopsin B, cis-dehydroisosolenopsin B, trans-dehydrosonenopsin C, cis-dehydroisosolenopsin C, trans-dehydrosonenopsin D, cis-dehydroisosolenopsin D, or a mixture thereof.

The insecticide may be a natural insecticide or a commercial toxin. Natural insecticides commonly used to control ants include diatomaceous earth (silicon dioxide), glass cleaner and liquid detergent, ground black pepper, ground red pepper, peppermint, tea tree essential oil, lemon eucalyptus essential oil, oil of lemon eucalyptus (OLE), white vinegar, boiling water, corn starch, cinnamon leaf essential oil, neem oil, coffee grounds, boric acid, borax (sodium tetraborate), lemon juice, and citrus rinds from lemons or oranges. Current bait traps contain boric acid, borax, abamectin, fipronil, indoxacarb, metaflumizone, methoprene, pyriproxyfen, spinosad or hydramethylnon. Many commercial toxins have negative impact on the environment. For example, recently, hydramethylnon has been found to be toxic to fish, and slightly toxic to bees, people, and other mammals.

In an embodiment, the invention relates to a method for selectively attracting fire ants over non-target organisms, said method comprising treating an object or area with an effective amount of a composition comprising at least one fire ant food source, at least one fire ant venom alkaloid, optionally a carrier, and optionally an insecticide, wherein the composition presents with enhanced selectively for fire ants over non-target organisms.

In an embodiment, the invention relates to a kit comprising at least one fire ant food source, at least one fire ant venom alkaloid, optionally a carrier, and optionally an insecticide to be used as a bait with enhanced selectively for fire ants over non-target organisms.

Unless otherwise explained, all technical and scientific terms used herein have the same meaning as commonly understood by one of ordinary skill in the art to which this disclosure belongs.

As used herein, the singular terms “a”, “an”, and “the” include plural referents unless context clearly indicates otherwise. Similarly, the word “or” is intended to include “and” unless the context clearly indicate otherwise.

As used herein, the term “non-target organisms” refers to insects other than fire ants.

As used herein, the term “insecticide” refers to an agent that destroys one or more species of insects as well as other small pests, such as mites or nematodes. Insecticides can be classified into two major groups: systemic insecticides, which have residual or long term activity; and contact insecticides, which have no residual activity. The mode of action describes how the pesticide kills or inactivates a pest. It provides another way of classifying insecticides. The most commonly used insecticides in agricultural, public health, and industrial applications are the organophosphates, pyrethroids, and carbamates. Natural, non-toxic commercial repellents also exist.

As used herein, the terms “optional” or “optionally” mean that the subsequently described event or circumstance may or may not occur, and that the description includes instances in which said event or circumstance occurs and instances where it does not. For example, the phrase “optionally comprising a carrier” means that the composition may or may not contain a carrier and that this description includes compositions that contain and compositions that do not contain a carrier. Also, by example, the phrase “optionally adding a carrier” means that the method may or may not involve adding a carrier to the composition used in the method, and that this description includes methods that involve and do not involve adding a carrier to the fire ant-attracting composition.

The term “carrier” as used herein includes carrier materials such as those described below. The carrier can be any agronomically, physiologically, or pharmaceutically acceptable carrier. The carrier may be a liquid or a solid. As is known in the art, the carrier to be used refers to a substrate such as a mineral oil, a paraffin, a silicon oil, water, a membrane, a sachet, a disk, a rope, a vial, a tube, a septa, a resin, a hollow fiber, a microcapsule, a filter, a gel, a fiber, a natural polymer, a synthetic polymer, an elastomer, or the like. All of these substrates may be used for the controlled release of an effective amount of a composition containing the compounds disclosed herein in general and are well known in the art. Suitable carriers are well-known in the art and are selected in accordance with the ultimate application of interest. Agronomically acceptable carriers include an aqueous solution, a glycol, an alcohol, a ketone, an ester, a hydrocarbon, a halogenated hydrocarbon, a polyvinyl chloride, and mixtures thereof. In addition, solid carriers may be such as a clay, a laminate, a cellulosic matrix, a rubber matrix, a synthetic polymer matrix, or the like. Pregel defatted corn grit is commonly used in fire ant bait products. The carrier or carrier material as used herein, and also fire ant food source, is defined as not including the body of fire ants.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013): “ . . . Written support for a negative limitation may also be argued through the absence of the excluded element in the specification, known as disclosure by silence . . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . This case shows that written description support for a negative limitation can be found by one or more disclosures of an embodiment that obeys what is required by the negative limitation . . . .”

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Materials and Methods

The materials and methods used in this disclosure are outlined in this example.

Ant feeding bioassays—Multiple-choice and a paired two-choice bioassays were used in this study. An exemplary schematic of the multichoice bioassay field feeding setup is shown in FIG. 1A, and an exemplary schematic of the two-choice bioassay field feeding setup is shown in FIG. 1B. Soybean oil was used as a food source for all the bioassays (Great Value, purchased from Walmart in Greenville Mississippi, USA). The feeding apparatus was a filtered 1-ml pipette tip with the part 0.5 cm below the filter removed. In multiple-choice bioassays, five concentrations of the test compounds were tested with untreated soybean oil as a control, and in two-choice bioassays, the compound at certain concentration was tested against the control oil. Eighty microliter soybean oil was loaded onto each filter. After being weighed, the apparatuses with oil were placed in the field for about 2 hours. The apparatuses were then collected and frozen under −40° C. to kill all ants. The apparatuses were weighed again after all ants were removed from the apparatuses. The difference in the weight of apparatuses before and after the feeding bioassays was the oil consumption. Feeding sites were at least 10 m away from each other for fire ants, and 3 m away for little black ants and for thief ants. The difference in oil consumption among/between treatment and control apparatuses was used to evaluate the effect of tested compound on the feeding of fire ants. For multiple-choice bioassays, a one-way ANOVA was performed to compare the effect of different concentrations of tested compound on the percentage of oil consumption. Tukey's HSD test was used for multiple comparisons. A paired t test was used in statistical analysis for the two-choice bioassays.

Multiple choice bioassays—Ten concentrations of trans-solenopsis A were tested in two separate multiple-choice bioassays. The first multiple-choice bioassay included concentrations of 0.00 (control), 6.6, 3.3, 1.7, 0.8 and 0.4 mg/g trans-solenopsis A, and the second multiple-choice bioassay included 0.00, 0.2, 0.10. 0.05, 0.03 and 0.015 mg/g trans-solenopsis A. There were five replicates for the first multiple-choice bioassay and seven replicates for the second multiple-choice bioassay.

Two choice bioassays—Two-choice bioassays were conducted at six concentrations of trans-solenopsis A in soybean oil, including 6.6, 3.3, 1.7, 0.8, 0.4, and 0.2 mg/g for fire ants and little black ants, and four concentrations for thief ants including 6.6, 3.3, 1.7, and 0.8 mg/g. Feeding sites were selected using blank bait (untreated soybean oil in the feeding apparatuses). Blank baits were placed at the flagged sites for 30 minutes before the bioassay, and active feeding sites then used for the bioassays. Bioassays on fire ants were conducted in open area where most baits were hit by fire ants. Bioassays on little black ants and thief ants were conducted under the bushes, since baits under the bushes had more chances to be hit by little black ants or thief ants.

### Example 2

### Effect of Trans-Solenopsis on Fire Ant Feeding Behavior in Multiple Choice and Two Choice Bioassays

The effect of the addition of trans-solenopsis A to soybean oil on the feeding behavior of fire ants was determined.

Ten concentrations of trans-solenopsis A in soybean oil were tested in two separate multiple-choice bioassays on fire ants. The results are shown in FIG. 2A and FIG. 2B. In both sets of multiple-choice bioassays different concentrations of trans-solenopsis A had no significant effect on oil consumption by fire ants. As seen in FIG. 2A, for the first set of concentrations. df=5, F=2.2, P=0.076, and as seen in FIG. 2B for the second set of concentrations df=5, F=0.6, P=0.703. Mean oil consumption percentage (%) of each choice over the total oil consumption were used in one-way ANOVA analysis. There was no significant difference in oil consumption among different concentrations for both sets of multiple-choice bioassays.

Two-choice bioassays on fire ants were conducted at each of six concentrations of trans-solenopsis A in soybean oil, including 6.6, 3.3, 1.7, 0.8, 0.4, and 0.2 mg/g. The result was shown in FIG. 3A to FIG. 3F. Adding synthetic trans-solenopsin A into the soybean oil did not affect the feeding preference of fire ants to the soybean oil, even at very high concentration, such as 6.6 mg/g (6600 ppm) (df=7, t=0.91, P=0.39). In fact, at certain concentrations, such as 0.42 and 0.27 mg/g (420, 270 ppm), fire ants even feed preferentially on soybean oil containing trans-solenopsin A (at 0.42 mg/g, df=6, t=−2.33, P=0.0585; at 0.42 mg/g, df=7, t=−2.37, P=0.049).

The results in this example show that there was no significant difference in fire ant oil consumption when trans-solenopsis A was added to soybean oil.

### Example 3

### Effect of Trans-Solenopsis on Little Black Ant and Thief Ant Feeding Behavior in Multiple Choice and Two Choice Bioassays

The effect of the addition of trans-solenopsis A to soybean oil on the feeding behavior of little black ants and thief ants was determined.

Two-choice bioassays on little black ants were conducted at each of six concentrations of trans-solenopsis A in soybean oil, including 6.6, 3.3, 1.7, 0.8, 0.4, and 0.2 mg/g. The results are shown in FIG. 4A to FIG. 4F. Synthetic trans-solenopsin A at concentrations of 6.6, 3.3, 1.66, and 0.83 significantly inhibited the feeding of little black ants. At 6.6 mg/g, the feeding of little black ants was almost completely shut down. At 0.42 mg/g, the inhibition was very close to be statistically significant (P=0.07). A paired t test was used in data analysis at each concentration. Note: at concentrations >0.42 mg/g, trans-solenopsin A significantly inhibited the feeding of little black ants on soybean oil (P<=0.045).

Two-choice bioassays on thief ants were conducted at each of four concentrations of trans-solenopsis A in soybean oil, including 6.6, 3.3, 1.7, and 0.8 mg/g. The results are shown in FIG. 5A to FIG. 5D. Synthetic trans-solenopsin A at concentrations of 6.6, 3.3, and 1.66 significantly inhibited the feeding of thief ants. At 6.6 mg/g, the feeding of thief ants was completely shut down. At 0.80 mg/g, the inhibition was not statistically significant (P=0.14). A paired t test was used in data analysis at each concentration. Note: at concentrations >=1.66 mg/g, trans-solenopsin A significantly inhibited the feeding of thief ants on soybean oil (P<=0.005).

The results obtained in this example show that at concentrations >0.42 mg/g, trans-solenopsin A significantly inhibited the feeding of little black ants on soybean oil, and at concentrations >1.66 mg/g, trans-solenopsin A significantly inhibited feeding of thief ants on soybean oil.

We claim:

1. A composition comprising at least one fire ant food source and at least one fire ant venom alkaloid, wherein the composition optionally comprises a carrier and/or an insecticide.

2. The composition of claim 1, wherein the fire ant food source is a vegetable oil.

3. The composition of claim 2, wherein the vegetable oil is canola oil, cottonseed oil, grapeseed oil, rapeseed oil, soybean oil, safflower oil, peanut oil, corn oil, olive oil, palm oil, or sunflower oil.

4. The composition of claim 2, wherein the vegetable oil is soybean oil.

5. The composition of claim 1, wherein the composition comprises a carrier.

6. The composition of claim 5, wherein the carrier is an agronomically-, physiologically-, or pharmaceutically-acceptable carrier.

7. The composition of claim 5, wherein the carrier is at least one of a mineral oil, a paraffin, a silicon oil, water, a membrane, a sachet, a disk, a rope, a vial, a tubes, a septa, a resin, a hollow fiber, a microcapsule, a filter, a gel, a fiber, a natural polymer, a synthetic polymer, an elastomer, or a mixture thereof.

8. The composition of claim 5, wherein the carrier is at least one of an aqueous solution, a glycol, an alcohol, a ketone, an ester, a hydrocarbon, a halogenated hydrocarbon, a polyvinyl chloride, a clay, a laminate, a cellulosic matrix, a rubber matrix, a synthetic polymer matrix, or a mixture thereof.

9. The composition of claim 1, wherein the at least one fire ant venom alkaloid is a 2,6-dialkyl(or alkenyl)piperidine, a 2-methyl-6-alkyl (or alkenyl)pyridine, a 2-methyl-6-alkyl (or alkenyl)piperideine, or a mixture thereof.

10. The composition of claim 9, wherein the at least one fire ant venom alkaloid is a 2,6-dialkyl(or alkenyl)piperidine (solenopsin).

11. The composition of claim 10, wherein the solenopsin is trans-solenopsin A, cis-isosolenopsin A, trans-solenopsin B, cis-isosolenopsin B, trans-solenopsin C, cis-isosolenopsin C, trans-solenopsin D, cis-isosolenopsin D, trans-dehydrosonenopsin A, cis-dehydroisosolenopsin A, trans-dehydrosonenopsin B, cis-dehydroisosolenopsin B, trans-dehydrosonenopsin C, cis-dehydroisosolenopsin C, trans-dehydrosonenopsin D, or cis-dehydroisosolenopsin D.

12. The composition of claim 11, wherein the solenopsin is trans-solenopsin A.

13. A method for selectively attracting fire ants over non-target organisms, said method comprising treating an object or area with an effective amount of a composition comprising at least one fire ant food source, at least one fire ant venom alkaloid, optionally a carrier, and optionally an insecticide, wherein the composition selectively attracts fire ants over non-target organisms.

14. The method of claim 13, wherein the at least one fire ant venom alkaloid in the composition is at least one of a 2,6-dialkyl(or alkenyl)piperidine, a 2-methyl-6-alkyl (or alkenyl)pyridine, a 2-methyl-6-alkyl (or alkenyl)piperideine, or a mixture thereof.

15. The method of claim 13, wherein the non-target organisms are ants.

16. The method of claim 13, wherein the vegetable oil is canola oil, cottonseed oil, grapeseed oil, rapeseed oil, soybean oil, safflower oil, peanut oil, corn oil, olive oil, palm oil, or sunflower oil.

17. The method of claim 13, wherein the composition further comprises an insecticide.

18. A kit comprising at least one fire ant food source, and at least one fire ant venom alkaloid, optionally a carrier, and optionally an insecticide.
